(19) United States
(12) Patent Application Publication
(10) Pub. No.: US 2010/0329958 A1
(43) Pub. Date: Dec. 30, 2010

(54) METHOD FOR PRODUCTION OF PURIFIED SILICON

(75) Inventors: Tomohiro Megumi, Niihama-shi (JP); Hiroshi Tabuchi, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignee: Sumitomo Chemical Company, Limited, Chuo-ku, Tokyo (JP)

(21) Appl. No.: 12/668,133

(22) PCT Filed: Jul. 11, 2008
(86) PCT No.: PCT/JP2008/062972

§ 371 Date: Jan. 7, 2010

(30) Foreign Application Priority Data
Jul. 12, 2007 (JP) 2007-182985
Oct. 5, 2007 (JP) 2007-261764
Nov. 28, 2007 (JP) 2007-307040

(51) Int. Cl. C01B 33/021

(52) U.S. Cl. 423/349

(57) ABSTRACT

A standard temperature gradient (T₀) and a standard solidification rate (R₀) which meet the formula (1) are determined in advance based on C₁₀ₘₐₓ and Y₀. k=[K₁×Ln(R₀)+K₂]×[K₃×exp[K₄×R₀×(K₅×C₂+K₆)]]×[K₇×T₀+K₈]−K₉ (1) wherein k represents a coefficient selected from a range from 0.9 time to 1.1 times an aluminum effective distribution coefficient (k′) so measured as to meet the formula (2): C₁₀ₘₐₓ=k′×C₂×(1−Y₀)^{k′-1} (2) wherein k′ represents analuminum effective distribution coefficient; C₂ represents the concentration of aluminum in a silicon molten solution raw material.

### TECHNICAL FIELD

The present invention relates to a method for producing refined silicon, and specifically relates to a method for producing refined silicon by a so-called directional solidification method whereby a raw silicon melt containing aluminum is cooled to solidify in a mold with a temperature gradient (T) provided unidirectionally.

### BACKGROUND ART

As to a method for producing refined silicon (1) by removing aluminum from a raw silicon melt containing aluminum (2), a so-called directional solidification method whereby the raw silicon melt (2) is cooled in a mold (3) with a temperature gradient (T) provided unidirectionally as shown in FIG. 1 has been known. According to this method, the raw silicon melt (2) is solidified with segregating aluminum from a low temperature side (21) to a high temperature side (22) of the temperature gradient (T) to form a directionally solidified silicon body (4), and thus the directionally solidified silicon (4) is formed of a refined silicon region (41) that is in a low temperature side (21) of the temperature gradient (T) provided in the solidification and has a comparatively low aluminum concentration (C) and a crude silicon region (45) that is in a high temperature side (22) of the temperature gradient (T) and has a comparatively high aluminum concentration (C). By cutting off the crude silicon region (45) of those regions from the directionally solidified silicon body (4), desired refined silicon (1) can be obtained as the refined silicon region (41) having a comparatively low aluminum concentration (C) (JP-A No. 2004-196577).

As to the directional solidification method, it has been known that the greater the temperature gradient (T) or the lower a solidification rate (R), the more aluminum segregates in the high temperature side (22) and, therefore, the more refined silicon (1) having a maximum aluminum concentration can be obtained. However, a facility should be large in order to produce a large temperature gradient (T) and reduction in the slow solidification rate (R) is disadvantageous in production speed. Therefore, desired refined silicon (1) has been produced by controlling the temperature gradient (T) and the solidification rate (R) according to a target maximum aluminum concentration (C₁₀ₘₐₓ) of the refined silicon (1), and a target value (Y₀) of a yield ratio expressed by a ratio (M₁/M₂) of the mass (M₁) of the above-described refined silicon (1) to the mass (M₂) of the raw silicon melt (2) used.

### DISCLOSURE OF INVENTION

However, the relationship between the temperature gradient (T) as well as the solidification rate (R) and the yield ratio (Y) as well as the maximum aluminum concentration (C₁ₘₐₓ) of refined silicon (1) to be obtained has heretofore been unclear.

Therefore, in order to obtain refined silicon (1) having an aluminum concentration (C) being not higher than a target maximum aluminum concentration (C₁₀ₘₐₓ) at a target yield ratio (Y₀), an optimal temperature gradient (T) and an optimal solidification rate (R) have been determined through repetition of many trials and errors.

Thus, the present inventors intensively studied for developing a method that can produce refined silicon (1) having an aluminum concentration (C) being not higher than a target maximum aluminum concentration (C₁₀ₘₐₓ) at a target yield ratio (Y₀) without undergoing many trials and errors, and as a result, they have accomplished the present invention.

That is, the present invention provides a method for producing refined silicon (1) comprising:
obtaining a directionally solidified silicon body (4) that has a refined silicon region (41) with an aluminum concentration (C) being not higher than a target maximum aluminum concentration (C₁₀ₘₐₓ (ppm)) and a crude silicon region (45) with an aluminum concentration (C) being higher than the target maximum aluminum concentration (C₁₀ₘₐₓ) by cooling a raw silicon melt (2) containing aluminum in a mold (3), with a temperature gradient (T) provided unidirectionally, and
obtaining the refined silicon (1) having an aluminum concentration (C(ppm)) being not higher than the target maximum aluminum concentration (C₁₀ₘₐₓ) by cutting off the crude silicon region (45) from the obtained directionally solidified silicon body (4),
   wherein a standard temperature gradient (T₀ (° C./mm)) and a standard solidification rate (R₀ (mm/min)) that satisfy the following formula (1) are determined beforehand from the target maximum aluminum concentration (C₁₀ₘₐₓ) and a target value (Y₀) of a yield ratio expressed by a ratio (M₁/M₂) of the mass (M₁) of the refined silicon (1) to the mass (M₂) of the used raw material silicon melt (2), and the raw silicon melt (2) is cooled under a temperature gradient (T) falling within the range of the standard temperature gradient (T₀)±0.1° C. so that the solidification will proceed at a solidification rate (R) falling within the range of the standard solidification rate (R₀)±0.01 mm/min:

$$k = \{ \begin{matrix}{K}_{1} \times Ln \\ ( {R}_{0} ) + {K}_{2}\end{matrix} \} \times \{ \begin{matrix}{K}_{3} \times exp \\ [ \begin{matrix}{K}_{4} \times {R}_{0} \times \\ ( {K}_{5} \times {C}_{2} + {K}_{6} )\end{matrix} ]\end{matrix} \} \times \{ {K}_{7} \times {T}_{0} + {K}_{3} \} - {K}_{9} \qquad ( 1 )$$

wherein k is a coefficient selected from the range of from 0.9 to 1.1 times an effective aluminum distribution coefficient k′ determined so that the formula (2) will be satisfied:

C₁₀ₘₐₓ=k′×C₂×(1−Y₀)^{k-1} (2)

wherein C₁₀ₘₐₓ denotes the target maximum aluminum concentration (ppm) of the refined silicon, k′ denotes the effective aluminum distribution coefficient, C₂ denotes the aluminum concentration (ppm) of the raw silicon melt, and Y₀ denotes the target value of a yield ratio, and
K₁ denotes a constant selected from the range of 1.1×10⁻³±0.1×10⁻³,
K₂ denotes a constant selected from the range of 4.2×10⁻³±0.1×10⁻³,
K₃ denotes a constant selected from the range of 1.2±0.1,
K₄ denotes a constant selected from the range of 2.2±0.1,
K₅ denotes a constant selected from the range of −1.0×10⁻³±0.1×10⁻³,
K₆ denotes a constant selected from the range of 1.0±0.1,
K₇ denotes a constant selected from the range of −0.4±0.1,
K₈ denotes a constant selected from the range of 1.36±0.01,
K₉ denotes a constant selected from the range of 2.0×10⁻⁴ ±1.0×10⁻⁴,
R₀ denotes the standard solidification rate (mm/min), and
T₀ denotes the standard temperature gradient (° C./mm).

According to the production method of the present invention, a standard temperature gradient (T₀) and a standard solidification rate (R₀) for producing refined silicon (1) having an aluminum concentration (C) being not higher than a target maximum aluminum concentration (C₁₀ₘₐₓ) at a target yield ratio (Y₀) from a raw silicon melt (2) containing aluminum can be determined, and therefore it is possible to produce refined silicon (1) having an aluminum concentration (C) being not higher than a target maximum aluminum concentration (C₁₀ₘₐₓ) at a target yield ratio (Y₀) by cooling a raw silicon melt (2) so that the solidification will proceed at a temperature gradient (T) and a solidification rate (R) falling within the aforementioned ranges based on those standards.

### BRIEF DESCRIPTION OF DRAWINGS

FIG. 1 is a sectional view schematically showing a process of obtaining a directionally solidified silicon body from a raw silicon melt by a directional solidification method.

FIG. 2 is a sectional view schematically showing a process of obtaining refined silicon from a directionally solidified silicon body.

### DESCRIPTION OF NUMERICAL REFERENCES

1: Refined silicon
2: Raw silicon melt
21: Low temperature side of temperature gradient
22: High temperature side of temperature gradient
24: Solid phase
25: Liquid phase
26: Interface
3: Mold
4: Directionally solidified silicon body
41: Refined silicon region
45: Crude silicon region
5: Crude silicon
6: Heater
7: Furnace
8: Water cooling plate
T: Temperature gradient
Y₀: Target yield ratio

### MODE FOR CARRYING OUT THE INVENTION

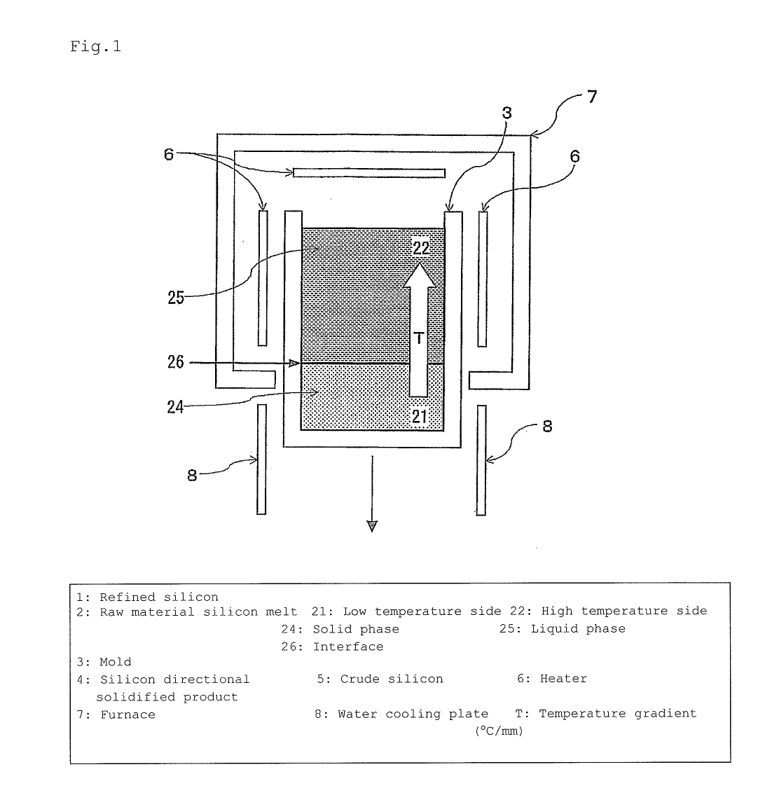

The production method of the present invention will be described below by using FIG. 1.

A raw silicon melt (2) to be used for the production method of the present invention is silicon that has been brought into a molten state by heating, and the temperature thereof exceeds the melting point of silicon (about 1414° C.) and is usually from 1420° C. to 1580° C.

The raw silicon melt (2) contains aluminum. The aluminum concentration (C₂) in the raw silicon melt (2) is usually from 10 ppm to 1000 ppm, and preferably 15 ppm or less. If the aluminum concentration (C₂) in the raw silicon melt is less than 10 ppm, further removal of aluminum is difficult. That the concentration is more than 1000 ppm is not practical because an excessive temperature gradient (T) and an excessive solidification rate (R) are required in order to obtain refined silicon (1).

The raw silicon melt (2) may contain, in addition to aluminum, impurity elements except for silicon and aluminum if in small amounts, specifically in 1 ppm or less in total, and particularly, it is preferable that the content of boron, phosphorus, or the like be as small as possible from the viewpoint that refined silicon (1) is obtained at a yield ratio equal to a target yield ratio (Y₀), and specifically, the content of each is preferably 0.3 ppm or less, and more preferably 0.1 ppm or less.

In the production method of the present invention, such a raw silicon melt (2) is cooled in a mold (3) in the same manner as in ordinary directional solidification methods. A mold that is inert to the raw silicon melt (2) and has heat resistance is usually used as the mold (3), and specifically, a mold made of carbon, such as graphite, silicon carbide, nitrogen carbide, alumina (aluminum oxide), silica (silicon oxide), such as quartz, or the like is used.

The cooling is performed with a temperature gradient (T) provided unidirectionally to the raw silicon melt (2). The temperature gradient (T) should only be provided unidirectionally, and may be provided horizontally, so that the low temperature side (21) and the high temperature side (22) are at the same level, or may be provided vertically so that the low temperature side (21) will be positioned above and the high temperature side (22) will be positioned below. Usually, the temperature gradient (T) is provided vertically so that the low temperature side (21) will be positioned below and the high temperature side (32) will be positioned above. The temperature gradient (T) is usually from 0.2° C./mm to 1.5° C./mm, preferably from 0.4° C./mm to 0.9° C./mm, and more preferably 0.7° C./mm or more because it is practical in that an excessive facility is not required.

The temperature gradient (T) can be provided by, for example, a method whereby a heater (6) is provided to heat the upper side of a mold (3) with the heater (6) in a furnace (7) whose lower side is opened to the atmosphere and simultaneously, the lower side of the mold is cooled below the furnace (7). Although the lower side of the mold (3) may be cooled by a method whereby it is allowed to cool in the atmosphere, it may be cooled with a water-cooling plate (8) which is provided, for example, on the lower side of the furnace (7) depending on the temperature gradient (T).

The raw silicon melt (2) can be cooled, for example, by lowering the mold (3) containing the silicon melt (2) to lead it out of the furnace (7) from its bottom. As a result of the cooling of the raw silicon melt (2) in such a manner, the raw silicon melt (2) solidifies while forming a solid phase (24) from its low temperature side (21), eventually becoming a directionally solidified silicon body (4).

The solidification rare (R) is expressed as a rate of movement of an interface (26) between the solid phase (24) to be formed from the low temperature side (21) by cooling and the liquid phase (25) that has not solidified yet in the high temperature side (22), and can be controlled with a rate at which the mold (3) moves when the mold (3) is moved to the outside of the furnace (7).

In a process of thus solidifying the raw silicon melt (2) by cooling, aluminum contained in the raw silicon melt (2) segregates in the high temperature side (22).

Therefore, in the directionally solidified silicon body (4) after the solidification, the aluminum content (C) increases unidirectionally from the low temperature side (21) of the temperature gradient (T) toward the high temperature side (22). In this solidified body (4), a region that was in the low temperature side (21) of the temperature gradient (T) in the cooling process has become a refined silicon region (41) with a smaller aluminum content, and a region that was in the high temperature side (22) has become a crude silicon region (45) containing a larger amount of aluminum having segregated. Cutting off the crude silicon region (45) from such a directionally solidified silicon body (4) makes it possible to obtain desired refined silicon (1). A method of cutting the crude silicon region (45) is not particularly limited, and the crude silicon region (45) may be excised by cutting it with an ordinary method using a diamond cutter or the like.

In the production method of the present invention, the temperature gradient (T) is in the range of a standard temperature gradient (T₀)±0.1° C./mm, and preferably in the range of the standard temperature gradient (T₀)±0.05° C./mm, and a solidification rate (R) is in the range of a standard solidification rate (R₀)±0.01° C./mm, and preferably in the range of the standard solidification rate (R₀)±0.005° C./mm.

The standard temperature gradient (T₀) and the standard solidification rate (R₀) are determined from the formula (1) provided above. The effective aluminum distribution coefficient k in the formula (1) is determined so that it will satisfy the formula (2) provided above.

This formula (2) is derived from a formula (2-1) that represents a relationship between a solidification ratio (f) representing a proportion of the used raw silicon melt (2) accounted for by a solidified fraction having become a solid phase (23) during a process of solidifying the raw silicon melt (2) by cooling and an aluminum concentration (C) in a part that became a solid phase (23) immediately before:

C=k′×C₂×(1−f)^{k′-1} (2-1)

wherein C denotes an aluminum concentration (ppm) in the liquid phase, k′ denotes an effective aluminum distribution coefficient, C₂ denotes an aluminum concentration (ppm) of the used raw silicon melt (2), and f denotes a solidification ratio. This formula (2-1) is a relational expression generally called the Scheil's equation [“Solidification of Metals” (published on Dec. 25, 1971, by Maruzen Company, Limited.) pp. 121 to 134.]

The formula (1) is a formula that represents a relationship between such an effective aluminum distribution coefficient (k) and a solidification rate as well as a temperature gradient and that was found first by the present inventors. The production method of the present invention is one whereby a standard temperature gradient (T₀) and a standard solidification rate (R₀) satisfying the formula (1) are used as standards and a raw silicon melt (2) is solidified so that solidification will proceed at a temperature gradient (T) and a solidification rate (R) falling within the ranges stipulated in the present invention.

In the directionally solidified silicon body (4) obtained by solidifying the raw silicon melt (2) by the method of the present invention, the low temperature side (21) of the temperature gradient (T) in the cooling process is a refined silicon region (41) and the high temperature side (22) is a crude silicon region (45). Since the proportion accounted for by the refined silicon region (41) in the directionally solidified silicon body (4) is as represented by a target yield ratio (Y₀), the crude silicon region (45) can be removed by cutting the directionally solidified silicon body (4) at a portion that corresponds to the target yield ratio (Y₀), and thus desired refined silicon (1) can be obtained.

The obtained refined silicon (1) may be refined further by such a method as acid wash. mineral acid, such as hydrochloric acid, nitric acid, and sulfuric acid, is used usually as the acid to be used for the acid wash, and an acid with less metallic impurities is usually used from the viewpoint of contamination prevention. It is also possible to obtain refined silicon with a further reduced aluminum content by heating the obtained refined silicon (1) to fusion and then using it as a raw silicon melt (2) in the production method of the present invention.

The crude silicon (5) that has been removed can be used again as a raw silicon melt (2) of the present invention after being heated to fusion together with silicon having an aluminum content smaller than that of the crude silicon (5).

The refined silicon (1) obtained by using the production method of the present invention can be used suitably as, for example, raw materials for solar batteries.

### EXAMPLES

The present invention will be described below in more detail by way of examples, and the present invention is not limited by the examples.

### Reference Example 1

### Derivation of Formula (1)

### Experiment 1

A directionally solidified silicon body (4) was obtained by using a device depicted in FIG. 1 and cooling a raw silicon melt (2) having an aluminum concentration (C₂) of 1000 ppm in a mold (3) under a temperature gradient (T) (0.9° C./mm) so that solidification would proceed at a solidification rate (R) of 0.4 mm/min. In the resulting directionally solidified silicon body (4), aluminum concentrations (C) at portions with solidification ratios (f) in the cooling process of 0.18 and 0.38, respectively, were determined by ICP (inductively-coupled plasma) emission spectrometry or ICP mass spectrometry to be 4.0 ppm (f=0.18) and 4.9 ppm (f=0.38), respectively. From the solidification ratios (f) and the aluminum concentrations (C), an executive aluminum distribution coefficient (k) satisfying the formula (2-1) was determined to be 3.1×10⁻³. The results are collectively shown in Table 1.

### Experiments 2 and 3

Operations were carried out in the same manner as in Experiment 1 except for cooling raw silicon melts (2) having aluminum concentrations (C₂) provided in Table 1 instead of the raw aluminum melt (2) used in Experiment 1 under temperature gradients (T) provided in Table 1 so that solidification would proceed at solidification rates (R) provided in Table 1, and determining the aluminum concentrations (C) in the resulting directionally solidified silicon bodies (4) at portions with solidification ratios (f) in the cooling processes being values provided in Table 1. Respective executive aluminum distribution coefficients (k) were determined to be values provided in Table 1.

TABLE 1

| | C₂ | T | R | | C | |
|---|---|---|---|---|---|---|
| Experiments | ppm | ° C./mm | mm/min | f | ppm | k |
| 1 | 1000 | 0.9 | 0.4 | 0.18 | 4.0 | 3.1 × 10⁻³ |
| | | | | 0.38 | 4.9 | |
| 2 | 1000 | 0.9 | 0.2 | 0.17 | 2.8 | 2.5 × 10⁻³ |
| | | | | 0.38 | 4.2 | |
| 3 | 1000 | 0.9 | 0.05 | 0.32 | 1.2 | 0.8 × 10⁻³ |
| | | | | 0.72 | 2.6 | |

The relationship between the solidification rates (R) and the effective aluminum distribution coefficients (k) was determined from the results of Experiments 1 to 3 and, as a result, a formula (1-1) was obtained:

k={K₁′×Ln(R)+K₂′}

wherein k denotes an effective aluminum distribution coefficient and R denotes a solidification rate (mm/min). In the formula (1-1), K₁′ is 1.1×10⁻³ and K₂′ is 4.2×10⁻³.

The temperature gradients (T), the solidification rates (R) and the effective aluminum distribution coefficients (k) in Experiments 1 to 3 satisfy the formula (1-1).

### Experiments 4 to 6

Experiments 4 to 6 were carried out, in which the temperature gradients (T) of raw silicon melts (2) were equal to those of Experiments 1 to 3 provided above, but the aluminum concentrations (C₂) of the raw silicon melts (2) were different. The aluminum concentrations (C₂), the temperature gradients (T) and the solidification rates (R) of the raw material aluminum melts (2) were provided in Table 2. In the resulting directionally solidified silicon bodies (4), the aluminum concentrations (C) at portions with solidification ratios (f) in the cooling processes were determined to be values provided in Table 2 and, in the same manner as in Experiment 1, respective executive aluminum distribution coefficients (k) were determined to be values provided in Table 2.

TABLE 2

| | C₂ | T | R | | C | |
|---|---|---|---|---|---|---|
| Experiments | ppm | ° C./mm | mm/min | f | ppm | k |
| 4 | 100 | 0.9 | 0.2 | 0.17 | 0.4 | 4.1 × 10⁻³ |
| | | | | 0.45 | 1.1 | |
| 5 | 10 | 0.9 | 0.4 | 0.32 | 0.1 | 9.0 × 10⁻³ |
| | | | | 0.72 | 0.3 | |
| 6 | 10 | 0.9 | 0.2 | 0.20 | 0.05 | 4.2 × 10⁻³ |
| | | | | 0.52 | 0.17 | |

Experiments 4 to 6 are agree with Experiments 1 to 3 with respect to the temperature gradients (T) of the raw silicon melts (2) but are different with respect to the aluminum concentrations (C₂) of the raw silicon melts (2). The effective aluminum distribution coefficients (k) determined in Experiments 4 to 6 do not satisfy the formula (1-1) provided above.

As to a formula satisfying both the effective aluminum distribution coefficients (k) determined in Experiments 1 to 3 provided above and the effective aluminum distribution coefficients (k) determined in Experiments 4 to 6, a formula (1-2) was obtained:

$$k = \{ {K}_{1}^{′} \times Ln ( R ) + {K}_{2}^{′} \} \times \{ {K}_{3}^{′} \times exp [ {K}_{4}^{′} \times R \times ( {K}_{5}^{′} \times {C}_{2} + {K}_{6}^{′} ) ] \} \qquad ( 1 \text{-} 2 )$$

wherein k, R, K₁′ and K₂′ re the same in meaning as above, and C₂ denotes the aluminum concentration (ppm) of the raw aluminum melt. In the formula (1-2), K₃′ is 1.2, K₄′ is 2.2, K₅′ is −1.0×10⁻³, and K₆′ is 1.0.

The temperature gradients (T), the solidification rates (R), and the aluminum concentrations (C₂) and the effective aluminum distribution coefficients (k) of the used raw aluminum melts (2) in Experiments 1 to 3 and Experiments 4 to 6 satisfy the formula (1-2).

### Experiment 7

Experiment 7 was carried out, in which the aluminum concentration (C₂) of the raw material silicon melt (2) is equal to that of Experiment 2, but the temperature gradient (T) is different was performed. The aluminum concentration (C₂), the temperature gradient (T) and the solidification rate (R) of the raw aluminum melt (2) were as provided in Table 1. In the obtained directionally solidified silicon body (4), aluminum concentrations (C) in portions respectively having solidification ratios (f) in the cooling process of values provided in Table 3 were determined and, in the same manner as in Experiment 1, executive aluminum distribution coefficients (k) were respectively determined to be values provided in Table 3.

TABLE 3

| | C₂ | T | R | | C | |
|---|---|---|---|---|---|---|
| Experiment | Ppm | ° C./mm | mm/min | f | ppm | k |
| 7 | 1000 | 0.4 | 0.2 | 0.17 | 3.1 | 3.0 × 10⁻³ |
| | | | | 0.52 | 6.7 | |

In this Experiment 7, the aluminum concentration (C₂) of the raw silicon melt (2) is equal to that in Experiment 2, but the temperature gradient (T) is different. Therefore, the effective aluminum distribution coefficient (k) determined in Experiment 7 satisfies neither the formula (1-1) nor the formula (1-2) provided above.

As to a formula satisfying both of the effective aluminum distribution coefficients (k) determined in Experiments 1 to 3 and Experiments 4 to 6 provided above and the effective aluminum distribution coefficient (k) determined in Experiment 7, a formula (1-3) was obtained:

$$k = \{ \begin{matrix}{K}_{1}^{′} \times Ln \\ ( R ) + {K}_{2}^{′}\end{matrix} \} \times \{ \begin{matrix}{{K}_{3}}^{′} \times exp \\ [ \begin{matrix}{{K}_{4}}^{′} \times R \times \\ ( \begin{matrix}{{K}_{5}}^{′} \times \\ {C}_{2} + {{K}_{6}}^{′}\end{matrix} )\end{matrix} ]\end{matrix} \} \times \{ \begin{matrix}{{K}_{7}}^{′} \times T + \\ {{K}_{8}}^{′}\end{matrix} \} - {{K}_{9}}^{′} \qquad ( 1 \text{-} 3 )$$

wherein k, R, C₂, K₁′, K₂′, K₃′, K₄′, K₅′ and K₆′ are the same in meaning as above, and T denotes a temperature gradient (° C./mm). In the formula (1-3), K₇′ is −0.4, K₈′ is 1.36, and K₉′ is 2.0×10⁻⁴.

The temperature gradients (T), the solidification rates (R), and the aluminum concentrations (C₂) and the effective aluminum distribution coefficients (k) of the used raw aluminum melts (2) in Experiments 1 to 3, Experiments 4 to 6 and Experiment 7 satisfy the formula (1-3).

The standard temperature gradient (T₀) and the standard solidification rate (R₀) are respectively substituted in place of the temperature gradient (T) and solidification rate (R) in the formula (1-3) determined in the above description, and the values of K₁ to K₉ are made those in the formula (1) on the basis of the values of K₁′ to K₉′ provided above, respectively. As a result, the formula (1) is obtained.

### Example 1-1

A standard temperature gradient (T₀) and a standard solidification rate (R₀) that satisfy the formula (1), provided that the values of K₁ to K_{g} are the same as the values of K₁′ to K₉′, respectively, are determined where the aluminum concentration (C₂) of the raw material silicon melt (2) is 1000 ppm, the target maximum aluminum concentration (C₁₀ₘₐₓ) is 4.0 ppm, and the target value of the yield ratio (target yield ratio) (Y₀) is 0.18. The standard temperature gradient (T₀) is determined to be 0.9° C./mm and the standard solidification rate (R₀) is determined to be 0.4° C./mm.

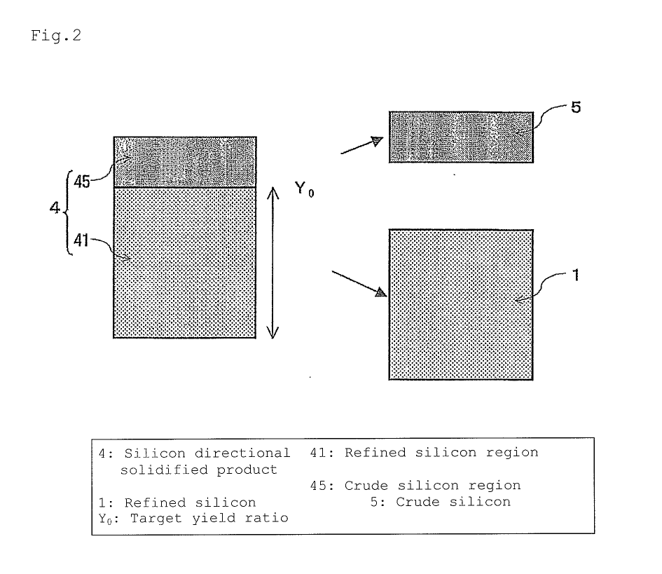

A directionally solidified silicon body (4) illustrated in FIG. 2 is obtained by cooling the raw silicon melt (2) having an aluminum concentration (C₂) of 1000 ppm in a mold (3) with a temperature gradient (T) of 0.9° C./mm provided by using a device shown in FIG. 1 so that solidification will proceed at a solidification rate (R) of 0.4 mm/min.

As shown in FIG. 2, the obtained directionally solidified silicon body (4) is cut at a portion having a solidification ratio (f) of 0.18 in a cooling process, and a region (45) in a high temperature region side (22) of a temperature gradient (T) is removed, yielding refined silicon (1). The maximum aluminum concentration (C₁ₘₐₓ) of the obtained refined silicon (1) is 4.0 ppm.

### Examples 1-2 and Examples 2 to 7

A standard temperature gradient (T₀) and a standard solidification rate (R₀) are obtained in the same manner as in Example 1 except that the aluminum concentration (C₂), the target maximum aluminum concentration (C₁₀ₘₐₓ), and the target yield ratio (Y₀) of a raw silicon melt (2) were respectively set are adjusted, respectively, as shown in Table 4. A directionally solidified silicon body (4) is obtained in the same manner as in Example 1 except that a temperature gradient (T) is adjusted to the same as the obtained standard temperature gradient (T₀) and a solidification rate (R) is adjusted to the same as the obtained standard solidification rate (R₀), and then it is cut at a portion having a solidification ratio (f) in the cooling process that is of the same value as the target solidification ratio (Y₀), yielding refined silicon (1). This refined silicon (1) has a maximum aluminum concentration (C₁ₘₐₓ) provided in Table 4.

TABLE 4

| | C₂ | C₁₀ₘₐₓ | | T₀ | R₀ | T | R | | C₁ₘₐₓ |
|---|---|---|---|---|---|---|---|---|---|
| Examples | ppm | ppm | Y₀ | ° C./mm | mm/min | ° C./mm | mm/min | f | ppm |
| 1-1 | 1000 | 4.0 | 0.18 | 0.9 | 0.4 | 0.9 | 0.4 | 0.18 | 4.0 |
| 1-2 | | 4.9 | 0.38 | | | | | 0.38 | 4.9 |
| 2-1 | 1000 | 2.8 | 0.17 | 0.9 | 0.2 | 0.9 | 0.2 | 0.17 | 2.8 |
| 2-2 | | 4.2 | 0.38 | | | | | 0.38 | 4.2 |
| 3-1 | 1000 | 1.2 | 0.32 | 0.9 | 0.05 | 0.9 | 0.05 | 0.32 | 1.2 |
| 3-2 | | 2.6 | 0.72 | | | | | 0.72 | 2.6 |
| 4-1 | 100 | 0.4 | 0.17 | 0.9 | 0.2 | 0.9 | 0.2 | 0.17 | 0.4 |
| 4-2 | | 1.1 | 0.45 | | | | | 0.45 | 1.1 |
| 5-1 | 10 | 0.1 | 0.32 | 0.9 | 0.4 | 0.9 | 0.4 | 0.32 | 0.1 |
| 5-2 | | 0.3 | 0.72 | | | | | 0.72 | 0.3 |
| 6-1 | 10 | 0.05 | 0.20 | 0.9 | 0.2 | 0.9 | 0.2 | 0.20 | 0.05 |
| 6-2 | | 0.17 | 0.52 | | | | | 0.52 | 0.17 |
| 7-1 | 1000 | 3.1 | 0.17 | 0.4 | 0.2 | 0.4 | 0.2 | 0.17 | 3.1 |
| 7-2 | | 6.7 | 0.52 | | | | | 0.52 | 6.7 |

### INDUSTRIAL APPLICABILITY

According to the production method of the present invention, a standard temperature gradient (T₀) and a standard solidification rate (R₀) for production of refined silicon (1) having an aluminum concentration (C) being not higher than a target maximum aluminum concentration (C₁₀ₘₐₓ) at a target yield ratio (Y₀) from a raw silicon melt (2) containing aluminum can be determined, and therefore it is possible to produce refined silicon (1) having an aluminum concentration (C) being not higher than a target maximum aluminum concentration (C₁₀ₘₐₓ) at a target yield ratio (Y₀) by cooling a raw silicon melt (2) so that the solidification will proceed at a temperature gradient (T) and a solidification rate (R) falling within the aforementioned ranges based on those standards.

1. A method for producing refined silicon (1) comprising:
obtaining a directionally solidified silicon body (4) that has a refined silicon region (41) with an aluminum concentration (C) being not higher than a target maximum aluminum concentration (C₁₀ₘₐₓ (ppm)) and a crude silicon region (45) with an aluminum concentration (C) being higher than the target maximum aluminum concentration (C₁₀ₘₐₓ) by cooling a raw silicon melt (2) containing aluminum in a mold (3), with a temperature gradient (T) applied unidirectionally, and
obtaining the refined silicon (1) having an aluminum concentration (C (ppm)) being not higher than the target maximum aluminum concentration (C₁₀ₘₐₓ) by cutting off the crude silicon region (45) from the obtained directionally solidified silicon (4),
wherein a standard temperature gradient (T₀ (° C./mm)) and a standard solidification rate (R₉ (mm/min) that satisfy the following formula (1) are determined beforehand from the target maximum aluminum concentration (C₁₀ₘₐₓ), and a target value (Y₀) of a yield ratio expressed by a ratio (M₁/M₂) of the mass (M₁) of the refined silicon (1) to the mass (M₂) of the used raw silicon melt (2) and the raw silicon melt (2) is cooled under a temperature gradient (T) falling within the range of the standard temperature gradient (T₀)±0.1° C. so that the solidification will proceed at a solidification rate (R) falling within the range of the standard solidification rate (R₀)±0.01 mm/min:
k={K₁×Ln(R₀)+K₂}×{K₃×exp[K₄×R₀×(K₅×C₂+K₆)]}×{K₇×T₀+K₈}−K₉ (1)
wherein k is a coefficient selected from the range of 0.9 to 1.1 times an effective aluminum distribution coefficient k′ determined so that formula (2) will be satisfied:
C₁₀ₘₐₓ=k′×C₂×(1−Y₀)^{k′-1} (2)
wherein C₁₀ₘₐₓ denotes the target maximum aluminum concentration (ppm) of the refined silicon, k′ denotes the effective aluminum distribution coefficient, C₂ denotes the aluminum concentration (ppm) of the raw silicon melt, and Y₀ denotes the target value of a yield ratio; and
K₁ denotes a constant selected from the range of 1.1×10⁻³+0.1×1
K₂ denotes a constant selected from the range of 4.2×10⁻³±0.1×10⁻³,
K₃ denotes a constant selected from the range of 1.2±0.1,
K₄ denotes a constant selected from the range of 2.2±0.1,
K₅ denotes a constant selected from the range of −1.0×10⁻³+0.1×1
K₆ denotes a constant selected from the range of 1.0±0.1,
K₇ denotes a constant selected from the range of −0.4±0.1,
K₈ denotes a constant selected from the range of 1.36±0.01,
K₉ denotes a constant selected from the range of 2.0×10⁻⁴+1.0×10⁻⁴,
R₀ denotes the standard solidification rate (mm/min), and
T₀ denotes the standard temperature gradient (° C./mm).

2. The production method according to claim 1, wherein the target value (Y₀) of the yield ratio is 0.9 or less.

3. The production method according to claim 1, wherein the target maximum aluminum concentration (C₁₀ₘₐₓ) is 1/1000 times to 3/100 times the aluminum concentration (C₂) of the raw silicon melt (2).

4. The production method according to claim 2, wherein the target maximum aluminum concentration (C₁₀ₘₐₓ) is 1/1000 times to 3/100 times the aluminum concentration (C₂) of the raw silicon melt (2).
